(19) United States
(12) Patent Application Publication
(10) Pub. No.: US 2014/0236857 A1
(43) Pub. Date: Aug. 21, 2014

(54) Data Communication and Analytics Platform

(71) Applicant: BANK OF AMERICA CORPORATION, Charlotte, NC (US)

(72) Inventors: John A. Tsefrikas, Charlotte, NC (US); S. Michelle Ybarra, Mesa, AZ (US); Jeffrey R. Walls, Charlotte, NC (US); James A. Greco, Elkton, MD (US); Richard McKinnon, Garnet Valley, PA (US); Paul Schneider, Matthews, NC (US)

(73) Assignee: Bank of America Corporation, Charlotte, NC (US)

(21) Appl. No.: 13/875,987

(22) Filed: May 2, 2013

Related U.S. Application Data
(60) Provisional application No. 61/767,480, filed on Feb. 21, 2013.

(51) Int. Cl. G06Q 10/10

(52) U.S. Cl. CPC G06Q 10/10
USPC 705/342

(57) ABSTRACT

An interface receives a report associated with a customer from a first computer. The report includes customer attributes associated with the customer. A processor determines a customer identifier associated with the customer. The processor associates the customer identifier and customer attributes of the report to a customer identifier in a cross-reference table. The cross-reference table is internal to an enterprise and comprises the customer identifier and a universal key. The interface receives a request for an anonymized report from a second computer. The request comprises at least one requested customer identifier and indicates requested customer attributes. The processor determines a universal key for each requested customer identifier and generates the anonymized report. The anonymized report comprises the universal key associated with the requested customer identifier and the requested customer attributes. The interface communicates the anonymized report to a computer.

### RELATED APPLICATIONS

This application claims priority to U.S. Provisional Patent Application Ser. No. 61/767,480, entitled “DATA COMMUNICATION AND ANALYTICS PLATFORM,” which was filed on Feb. 21, 2013. U.S. Provisional Patent Application Ser. No. 61/767,480 is hereby incorporated by reference.

### TECHNICAL FIELD

This invention relates generally to communicating and analyzing data, and more particularly to a data communication and analytics platform.

### BACKGROUND

Enterprises handle large amounts of data and interact with external vendors to perform their business operations. In conventional systems, enterprises store large amounts of data on a single storage system. As another example, enterprises request information from external vendors. In certain instances, external vendors perform calculations for a request at the time of receiving the request. Additionally, to update a report, an external vendor communicates the report to an enterprise and the enterprise communicates the report update to the external vendor for the external vendor to implement on the external vendor's system.

Furthermore, government regulations may regulate information exchange between the external vendor and the enterprise, particularly if the exchanged information is related to customers. Complying with the government regulations may cause inefficiencies in the communication between the external vendor and the enterprise.

### SUMMARY OF EXAMPLE EMBODIMENTS

According to embodiments of the present disclosure, disadvantages and problems associated with a data communication and analytics platform may be reduced or eliminated.

In accordance with a particular embodiment of the present disclosure, an interface in an attribute calculation module external to an enterprise receives data from the enterprise. A processor performs one or more first calculations on the received data, wherein the first calculations comprise predetermined calculations to create attributes of the received data. The interface communicates the first calculated data to a database for storage, the database being external to the enterprise. The interface receives a request from a computer associated with the enterprise, wherein the request indicates criteria to conduct one or more second calculations on the first calculated data. The processor performs each of the second calculations on the first calculated data. The interface communicates the second calculated data to the computer associated with the enterprise.

In accordance with another aspect of the present invention, an interface in an attribute calculation module external to an enterprise receives a request for data from a computer associated with the enterprise. The processor determines attribute calculations from an attribute calculation rule set based on the request and calculates the determined attribute calculations on external data. The interface communicates the calculated external data to the computer associated with the enterprise. The interface receives an attribute calculation update to the attribute calculation rule set from an attribute management module associated with the enterprise. The processor updates the attribute calculation rule set based on the attribute calculation update.

In accordance with another aspect of the present invention, an interface receives a report associated with a customer from a first computer. The report includes customer attributes associated with the customer. A processor determines a customer identifier associated with the customer. The processor associates the customer identifier and customer attributes of the report to a customer identifier in a cross-reference table. The cross-reference table is internal to an enterprise and comprises the customer identifier and a universal key. The interface receives a request for an anonymized report from a second computer. The request comprises at least one requested customer identifier and indicates requested customer attributes. The processor determines a universal key for each requested customer identifier and generates the anonymized report. The anonymized report comprises the universal key associated with the requested customer identifier and the requested customer attributes. The interface communicates the anonymized report to a computer.

In accordance with another aspect of the present invention, an interface external to one or more storage systems receives transaction data from a plurality of data sources. A processor determines a transaction date of the received data. The processor determines the storage system in which to store the received data based on the transaction date of the received data, wherein a first storage system stores first data having a transaction date within a first predetermined period and a second storage system stores second data having a transaction date within a second predetermined period. The interface communicates the received data to the determined storage system for storage.

In accordance with another aspect of the present invention, a processor in an attribute retrieval module determines retrievable customer attributes from a plurality of data locations, wherein at least one of the retrievable customer attributes is retrieved from a data location external to the enterprise. The interface receives a customer attribute request from a first computer. The customer attribute request includes at least one customer identifier and requested customer attributes. The requested customer attributes included in the customer attribute request is a subset of the retrievable customer attributes. The processor determines the data location of each requested customer attribute and generates an information call for each data location. The information call comprises at least the customer identifier and one requested customer attribute. The interface communicates the information call to each data location. The interface receives a data report in response to the information call from each data location, the data report containing the customer attribute information associated with the customer identifier. The processor generates a complete data report based on the data report received from each data location, and the interface communicates the complete data report to the first computer.

Certain embodiments of the present disclosure may provide one or more technical advantages. A technical advantage of one embodiment includes pre-calculating and storing data at a remote vendor, thereby reducing response time and increasing efficiency when receiving a request. Another technical advantage includes allowing a module located in an enterprise to provide an update to the rule set of a module located at an external vendor, thereby providing greater efficiencies by reducing the number of transactions required between the enterprise and the external vendor to update the rule set. Yet another technical advantage includes a module located in the enterprise creating an anonymized report containing both historical and current customer information, thereby promoting greater visibility into a potential customer's attributes and providing more customer information for an enterprise to view. Yet another technical advantage includes a system to determine a storage system based on the transaction date of the data, which leads to greater efficiencies by utilizing various storage system technologies to store different types of data. Yet another technical advantage includes a system to determine the data location of requested customer attributes and gather the requested customer attributes from each data location, thereby increasing efficiency by automating the retrieval of data from different data locations.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates a system that facilitates the communication of data between a remote vendor, an enterprise, data sources, and computers;

FIG. 2 illustrates a particular embodiment of an attribute calculation module;

FIG. 3 illustrates a particular embodiment of an attribute management module;

FIG. 4 illustrates a particular embodiment of a universal keying module;

FIG. 5 illustrates a particular embodiment of a data manipulation module;

FIG. 6 illustrates an example method for separately calculating first and second calculations on data;

FIG. 7 illustrates an example method for communicating an attribute calculation update and/or a translation rule update;

FIG. 8 illustrates an example method for determining a universal key based on a customer identifier included in a report and transmitting an anonymized report with a universal key associated with a customer;

FIG. 9 illustrates an example method for determining a storage system to store received data based on the transaction date of the received data;

FIG. 10 illustrates a particular embodiment of an attribute retrieval module;

FIG. 11 illustrates a particular embodiment of a universal keying management module; and

FIG. 12 illustrates an example method for retrieving requested customer attributes based on a received customer attribute request.

### DETAILED DESCRIPTION

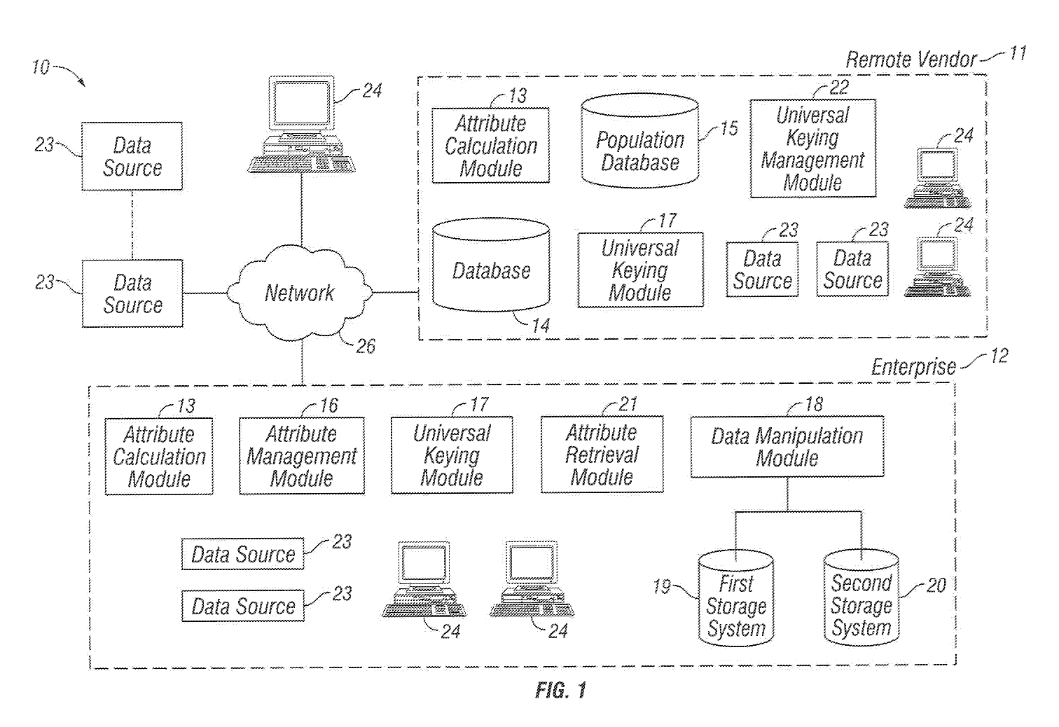

Embodiments of the present invention and its advantages are best understood by referring to FIGS. 1 through 12, like numerals being used for like and corresponding parts of the various drawings.

Enterprises may request information from external vendors. Typically, external vendors perform the calculations for a request at the time of receiving the request, which reduces efficiency. The teachings of this disclosure recognize that it would be desirable to provide a platform that performs an initial set of calculations on a received set of data, stores the pre-calculated data, and then performs a second set of calculations upon receiving a request for the data. An external vendor may perform the first calculations on a received set of data to store and then perform the second calculations when it receives the request. Pre-calculating and storing the data reduces response time and increases efficiency because the system performs fewer calculations after receiving the request for data.

In addition, enterprises may periodically request information from external vendors. In conventional systems, to update a report, an external vendor communicates a report to an enterprise, and the enterprise communicates the report update to the external vendor for the external vendor to implement on the external vendor's system. This process is time-consuming and inefficient. The teachings of this disclosure recognize that it would be desirable for a system within the enterprise to change a report received from an external vendor by directly updating the system in the external vendor. This platform allows a module located in the enterprise to provide an update to the rule set of a module located at the external vendor, which leads to greater efficiencies by reducing the number of transactions required between the enterprise and the external vendor to update the rule set.

Furthermore, government regulations may regulate information exchange between the external vendor and the enterprise, particularly if the exchanged information is related to customers. In particular, the government regulations may require the external vendor to anonymize customer-identifying information upon responding to a request for information. Typically, the external vendor communicates anonymized information to the enterprise, but the enterprise does not have the capability to associate this received information with historical customer information. Not having the association between the historical and current customer information is undesirable and inefficient. The teachings of this disclosure recognize that it would be desirable to provide a platform that receives customer information from an external vendor and associates the customer and customer information with a universal key. When a user requests an anonymized customer information report, the platform may create an anonymized report containing both historical and current customer information. This promotes greater visibility into a potential customer's attributes and improves efficiencies because more customer information will be available for the enterprise to view and use for analysis.

Moreover, enterprises may store large amounts of data in a storage system. In conventional systems, an enterprise stored its data on one storage system. This process is uneconomical and process-intensive. The teachings of this disclosure recognize that it would be desirable for a system within the enterprise to select a storage system from a plurality of storage systems in which to store data based on the transaction date of the data. This platform allows a system to determine a storage system based on the transaction date of the data, which leads to greater efficiencies by utilizing various storage system technologies to store different types of data.

FIG. 1 illustrates a system 10 that facilitates the communication of data between remote vendor 11, enterprise 12, data sources 23, and computers 24. More specifically, data is communicated between attribute calculation module 13, attribute management module 16, universal keying module 17, data manipulation module 18, attribute retrieval module 21, and universal keying management module 22 within remote vendor 11 and enterprise 12. Remote vendor 11, which may contain attribute calculation module 13, database 14, population database 15, universal keying module 17, universal keying management module 22, and one or more data sources 23; enterprise 12, which may contain attribute management module 16, universal keying module 17, data manipulation module 18, attribute retrieval module 21; one or more data sources 23; and one or more computers 24 may be communicatively coupled by network 26. Generally, attribute calculation module 13, attribute management module 16, universal keying module 17, data manipulation module 18, attribute retrieval module 21, and universal keying management module 22 interact to efficiently communicate data.

System 10 includes remote vendor 11, which may refer to an external vendor. Remote vendor 11 facilitates the calculation of data for use by enterprise 12 and communicates information regarding customers for use by enterprise 12. Remote vendor 11 may include attribute calculation module 13, database 14, population database 15, universal keying module 17, universal keying management module 22, one or more data sources 23, and one or more computers 24. Remote vendor 11 is any business or company that communicates with enterprise 12 over network 26. Remote vendor 11 may be multiple businesses or companies that communicate with enterprise 12 over network 26. Even though remote vendor 11 is referred to as a remote vendor, remote vendor 11 may include any suitable type of third-party entity in any suitable industry.

System 10 includes enterprise 12, which may refer to a financial institution, such as a bank. Enterprise 12 facilitates receiving information from remote vendor 11, data source 23, and computer 24. In addition, enterprise 12 facilitates communicating rule set updates and translation rule updates to remote vendor 11. Furthermore, enterprise 12 facilitates anonymizing reports with customer identifiers to or from remote vendor 11 and/or computers 24. Additionally, enterprise 12 facilitates the storage and retrieval of data based on the transaction date of the data and the storage and retrieval of data based on a customer attribute request. Enterprise 12 may include attribute management module 16, universal keying module 17, data manipulation module 18, first storage system 19, second storage system 20, attribute retrieval module 21, one or more data sources 23, and one or more computers 24. Even though enterprise 12 is referred to as a financial institution, enterprise 12 may include any suitable type of entity in any suitable industry.

To better understand the functions of system 10, an example of communicating a report will be used. However, it is understood that system 10 may be used in a variety of contexts and areas to help remote vendor 11 and enterprise 12 communicate data in an efficient manner, such as performing first and second calculations on data, updating a calculation rule set, providing a universal key for a received report, and storing data in an efficient manner.

Attribute calculation module 13 represents any suitable components, external to enterprise 12, that facilitates the calculating of first and second calculations separately on data. Attribute calculation module 13 enables a quicker response to requested information by limiting computations upon receiving a request. To facilitate this process, attribute calculation module 13 performs a first calculation on received data and performs a second calculation on the calculated data. Attribute calculation module 13 may be located in remote vendor 11 or any suitable area external to enterprise 12 that receives data from enterprise 12.

Attribute calculation module 13 may include a network service, any suitable remote service, a mainframe, a host computer, a workstation, a web server, a personal computer, a file server, or any other suitable device operable to communicate with enterprise 12, data sources 23, and computers 24. In some embodiments, attribute calculation module 13 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of attribute calculation module 13 may be performed by any suitable combination of one or more servers or other components at one or more locations. In the embodiment where the modules are servers, the servers may be public or private servers, and each server may be a virtual or physical server. The server may include one or more servers at the same or at remote locations. Also, attribute calculation module 13 may include any suitable component that functions as a server.

Database 14 represents a database that stores, either permanently or temporarily, a first calculated set of data from attribute calculation module 13. Database 14 includes any one or a combination of volatile or non-volatile local or remote devices suitable for storing information. For example, database 14 may include random access memory (RAM), read only memory (ROM), magnetic storage devices, optical storage devices, or any other suitable information storage device or a combination of these devices. Database 14 may include any suitable information for use in the operation of attribute calculation module 13. Additionally, database 14 may be included within attribute calculation module 13, rather than being a component external to attribute calculation module 13. Database 14 can be located in remote vendor 11, enterprise 12, or any other location suitable for database 14 to communicate with attribute calculation module 13.

Population database 15 is a database that stores a set of data for a group of individuals. For example, population database 15 may store customer information (e.g., Fair Isaac Corporation (“FICO”) scores) for all of the residents in a particular location, such as a town, city, state, region, country, or other location. Population database 15 represents a database that stores, either permanently or temporarily, a first calculated set of data from attribute calculation module 13. Population database 15 includes any one or a combination of volatile or non-volatile local or remote devices suitable for storing information. For example, population database 15 may include random access memory (RAM), read only memory (ROM), magnetic storage devices, optical storage devices, or any other suitable information storage device or a combination of these devices. Population database 15 may include any suitable information for use in the operation of attribute calculation module 13. Additionally, population database 15 may be included within attribute calculation module 13, rather than being a component external to attribute calculation module 13. Population database 15 may be located in remote vendor 11, enterprise 12, or any other location suitable for population database 15 to communicate with attribute calculation module 13.

Attribute management module 16 represents any suitable components that facilitate the communication of an attribute calculation update and/or a translation rule update to attribute calculation module 13. Attribute management module 16 may be located in enterprise 12 or any other location that allows attribute management module 16 to communicate with attribute calculation module 13. Attribute management module 16 may include a network server, any suitable remote server, a mainframe, a host computer, a workstation, a web server, a personal computer, a file server, or any other suitable device operable to communicate with attribute calculation module 13. In some embodiments, attribute management module 16 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of attribute management module 16 may be performed by any suitable combination of one or more servers or other components at one or more locations. In the embodiment where the modules are servers, the servers may be public or private servers, and each server may be a virtual or physical server. The server may include one or more servers at the same or at remote locations. Also, attribute management module 16 may include any suitable component that functions as a server.

Universal keying module 17 represents any suitable component that facilitates determining a universal key based on a customer identifier included in a report and transmitting an anonymized report with a universal key associated with a customer. Universal keying module 17 may be located in remote vendor 11, enterprise 12, or any other location that allows universal keying module 17 to communicate with computers 24. Universal keying module 17 may include a network server, any suitable remote server, a mainframe, a host computer, a workstation, a web server, a personal computer, a file server, or any other suitable device operable to communicate with computers 24. In some embodiments, universal keying module 17 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of universal keying module 17 may be performed by any suitable combination of one or more servers or other components at one or more locations. In the embodiment where the modules are servers, the servers may be public or private servers, and each server may be a virtual or physical server. The server may include one or more servers at the same or at remote locations. Also, universal keying module 17 may include any suitable component that functions as a server.

Data manipulation module 18 represents any suitable component that facilitates determining a storage system to store received data based on the transaction date of the received data. Data manipulation module 18 determines a transaction date of the received data. Data manipulation module 18 may be located in enterprise 12 or any other location that allows attribute management module 16 to communicate with computers 24. Data manipulation module 18 may include a network server, any suitable remote server, a mainframe, a host computer, a workstation, a web server, a personal computer, a file server, or any other suitable device operable to communicate with computers 24. In some embodiments, data manipulation module 18 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of data manipulation module 18 may be performed by any suitable combination of one or more servers or other components at one or more locations. In the embodiment where the modules are servers, the servers may be public or private servers, and each server may be a virtual or physical server. The server may include one or more servers at the same or at remote locations. Also, data manipulation module 18 may include any suitable component that functions as a server.

First storage system 19 receives data from data manipulation module 18 that has a transaction date within the first predetermined time period. First storage system 19 represents a data storage that is communicatively coupled to data manipulation module 18. Generally, first storage system 19 may be a data storage that provides efficient access from data manipulation module 32 to find and access data. For example, first storage system 19 may be a relational database (e.g., Structured Query Language (“SQL”) database). First storage system 19 may be used to store various types of information or data, which may be organized in any suitable manner. For example, the data stored in first storage system 19 may be organized according to specific data structures. Accordingly, the contents of first storage system 19 may be stored as dimensional, flat, hierarchical, network, object-oriented, relational, extensible markup language (“XML”), or other suitable format or a combination or two or more of these.

Second storage system 20 receives data from data manipulation module 18 that has a transaction date within a second predetermined time period. Second storage system 20 represents a data storage that is communicatively coupled to data manipulation module 18. Generally, second storage system 20 may be a data storage that is cost efficient to store a large amount of information. For example, second storage system 20 may be a non-relational database (e.g., Adobe™ Hadoop® database). Second storage system 20 may be used to store various types of information or data, which may be organized in any suitable manner. For example, the data stored in second storage system 20 may be organized according to specific data structures. Accordingly, the contents of second storage system 20 may be stored as dimensional, flat, hierarchical, network, object-oriented, relational, XML, or other suitable format or a combination or two or more of these.

Attribute retrieval module 21 represents any suitable component that facilitates the retrieval of requested customer attributes based on a customer attribute request. Attribute retrieval module 21 determines the data location of each requested customer attribute in the customer attribute request and generates an information call for each data location. Attribute retrieval module 21 may be located in enterprise 12 or any other location that allows attribute retrieval module 21 to communicate with computers 24. Attribute retrieval module 21 may include a network server, any suitable remote server, a mainframe, a host computer, a workstation, a web server, a personal computer, a file server, or any other suitable device operable to communicate with computers 24. In some embodiments, attribute retrieval module 21 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of attribute retrieval module 21 may be performed by any suitable combination of one or more servers or other components at one or more locations. In the embodiment where the modules are servers, the servers may be public or private servers, and each server may be a virtual or physical server. The server may include one or more servers at the same or at remote locations. Also, attribute retrieval module 21 may include any suitable component that functions as a server.

Universal keying management module 22 represents any suitable component that facilitates the communication of updates to one or more universal keying modules 17. Universal keying management module 22 may be located in remote vendor 11 or any other location that allows universal keying management module 22 to communicate with universal keying module 17. Universal keying management module 22 may include a network server, any suitable remote server, a mainframe, a host computer, a workstation, a web server, a personal computer, a file server, or any other suitable device operable to communicate with universal keying module 17. In some embodiments, universal keying management module 22 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of universal keying management module 22 may be performed by any suitable combination of one or more servers or other components at one or more locations. In the embodiment where the modules are servers, the servers may be public or private servers, and each server may be a virtual or physical server. The server may include one or more servers at the same or at remote locations. Also, attribute management module 16 may include any suitable component that functions as a server.

Data source 23 may represent any source of information that may be used by attribute calculation module 13, attribute management module 16, universal keying module 17, and/or data manipulation module 18. Data source 23 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of an entity and who provides such knowledge for communication to a attribute calculation module 13, attribute management module 16, universal keying module 17, and/or data manipulation module 18), one or more documents (such as a newspaper that includes articles or other information about the entity), the Internet (which may include articles and other information about the entity), an open source intelligence report, a media outlet (such as a television station or a radio station that broadcasts information that may be communicated to attribute calculation module 13, attribute management module 16, universal keying module 17, and/or data manipulation module 18), any other suitable source of information, or any combination of the preceding. In certain embodiments, attribute calculation module 13 may receive information from data sources 23 to perform a first set of calculations upon. Furthermore, in certain embodiments, attribute management module 16 may receive information from data sources 23 to create an attribute calculation update or a translation rule update to send to attribute calculation module 13. In addition, in certain embodiments, universal keying module 17 may receive customer information from data sources 23 to associate the customer information to a universal key. Moreover, in certain embodiments, data manipulation module 18 may receive data from data sources 23 to store in first storage system 19 and/or second storage system 20. Data sources 23 may be located in remote vendor 11, enterprise 12, or any other location that allows for data source 23 to communicate via network 26.

Computers 24 may be any device that interacts with system 10. For example, computers 24 may interact with attribute calculation module 13 to request information or to receive second calculated data or calculated external data. As an additional example, computers 24 may interact with universal keying module 17 to receive an anonymized report. As a final example, computers 24 may interact with data manipulation module 18 to request retrieval of stored data. Attribute calculation module 13 may perform second calculations on calculated data and return the requested information to computers 24. Computers 24 may use a processor and a memory to execute an application in order to perform any of the functions described herein. Computers 24 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Computers 24 may also include a user interface, such as a display, a touchscreen, a microphone, keypad, or other appropriate terminal equipment usable by a user.

Network 26 facilitates communications between components in remote vendor 11, components in enterprise 12, data sources 23, and computers 24. This disclosure contemplates any suitable network 26 operable to facilitate communication between the components of system 10. Network 26 may include any interconnecting system capable of transmitting audio, video, signals, data, messages, or any combination of the preceding. Network 26 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of network 26.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

In one exemplary embodiment of operation, attribute calculation module 13, located in remote vendor 11 or any suitable area external to enterprise 12, receives data from enterprise 12. The data received may be attributes concerning a customer, characteristics of a business, loan details, or any other information regarding users, financial accounts, products, and/or services. In certain embodiments, the data received may be attributes concerning a potential customer, an entity with an existing relationship with the bank, or any person or entity that is linked with an attribute. Attribute calculation module 13 may perform one or more first calculations on the received data. The calculations may consist of determining a FICO score from the received data, interest calculations of a proposed loan, credit risk of a proposed loan candidate, or any other calculations that may manipulate and/or transform the received data. Attribute calculation module 13 may associate the received data and calculated data and communicate the data to database 14 for storage. In certain embodiments, attribute calculation module 13 may receive additional data from enterprise 12. Attribute calculation module 13 performs the one or more first calculations on the received additional data and communicates the calculated additional data to database 14 for storage. In certain embodiments, attribute calculation module 13 accesses database 14 and/or population database 15 to perform one or more first calculations on data located in database 14 and/or population database 15.

Attribute calculation module 13 may receive a request from computer 24 associated with enterprise 12. The request may indicate criteria to conduct one or more second calculations on a requested population, the requested population being all or a portion of the first calculated data. The second calculations may comprise returning customer information for customers residing in a particular location, loan information for interest payments over a certain amount, proposed loan candidates with a credit risk above a certain threshold, or any other calculations that may manipulate and/or transform the first calculated data. First calculated data may comprise any data calculated or stored by attribute calculation module 13 prior to or concurrent with the request.

Attribute calculation module 13 determines the second calculations and requested population indicated in the request. In certain embodiments, attribute calculation module 13 may determine the data location of the requested population. For instance, attribute calculation module 13 may determine that the requested population requires attribute calculation module 13 to access database 14 for a subset of the requested population and population database 15 for a subset of the requested population. In addition, the request may not include second calculations, and attribute calculation module 13 may not need to perform second calculations on the retrieved customer information for the requested population.

Attribute calculation module 13 may communicate the calculated data to computer 24 associated with enterprise 12. In certain embodiments, attribute calculation module 13 may communicate the second calculated data to database 14 for storage.

In certain embodiments, attribute calculation module 13 accesses population database 15 to communicate customer attribute information regarding the general population (e.g., individuals without a pre-existing relationship with enterprise 11). Attribute calculation module 13 determines a random sample of instances in population database 15. The sampling may include random sampling, systematic sampling, stratified sampling, or any other sampling methods that provide a representation of instances in population database 15. Attribute calculation module 13 performs each of the first calculations and each of the second calculations on the random sample of instances in population database 15. Attribute calculation module 13 communicates the calculated sample of instances to computer 24 associated with enterprise 12.

In another exemplary embodiment of operation, attribute calculation module 13 may receive a request for attribute data from computer 24 associated with enterprise 12. Attribute calculation module 13 may determine attribute calculations from an attribute calculation rule set based on the request. The attribute calculations may consist of calculating a FICO score on external data, interest calculations of a proposed loan, credit risk of a proposed loan candidate, or any other calculations that may manipulate and/or transform the external data. Attribute calculations may be a singular calculation (e.g., calculate the amortization schedule for a specified loan) or a series of calculation (e.g., calculate the FICO score and then calculate a customer's credit worthiness using the calculated FICO score). These calculations may be performed without user intervention. Attribute calculation module 13 may perform the determined attribute calculations on external data. The external data may be located on database 14, population database 15, or any other storage unit external to enterprise 12. Attribute calculation module 13 may communicate the calculated external data to computer 24 associated with enterprise 12.

In certain embodiments, attribute calculation module 13 receives a request for both uncalculated data and calculated data from computer 24 associated with enterprise 12. Attribute calculation module 13 may associate the uncalculated external data to the calculated external data before communicating the external data to computer 24 associated with enterprise 12.

In another exemplary embodiment of operation, attribute calculation module 13 communicates the second calculated data or calculated external data to a governance team. A governance team may be located in enterprise 12 or external to enterprise 12, such as in remote vendor 11. A governance team generally provides support for the delivery of efficient and accountable governance and management processes across enterprise 12 and data communicated to and from enterprise 12. The governance team is any suitable entity that provides support for viewing, managing, implementing, or reporting the enterprise's processes. The governance team may send a transmission approval to attribute calculation module 13. The transmission approval may indicate that the governance team approves the communication of the second calculated data or calculated external data to computer 24. The governance team may send a transmission disapproval to attribute calculation module 13 indicating that the governance team does not approve of the communication of the second calculated data or calculated external data to computer 24. Based on the transmission approval or disapproval, attribute calculation module 13 will transmit the second calculated data or calculated external data to computer 24.

In certain embodiments, attribute calculation module 13 translates the first calculated data before communicating the first calculated data to database 14. Attribute calculation module 13 determines translation rules from a translation rule set based on the format required by database 34 and translates the first calculated data to the database format based on the translation rule. For example, attribute calculation module 13 uses translation rule set 206 to translate the first calculated data into a flat file and communicates the translated first calculated data to database 14. Generally, a flat file refers to a data file that contains records with no structured relationships.

In yet another exemplary embodiment of operation, attribute calculation module 13 translates the calculated external data before communicating the calculated external data to computer 24 associated with enterprise 12. Attribute calculation module 13 determines translation rules from a translation rule set based on the request and translates the calculated external data to an attribute format based on the translation rule. For example, the attribute format may be a specified format report requested by computer 24 to translate calculated external data into a productionalized format for use by computer 24. Translation rule set may include any operations that modify the calculated external data into a format requested by computer 24 associated with enterprise 12. For example, computer 24 may request a transaction date in DD/MM/YYYY format. Attribute calculation module 13, however, may report transaction date in a MM/DD/YYYY format. In this instance, attribute calculation module 13 will determine a translation rule from the translation rule set and modify the transaction date in MM/DD/YYYY format to DD/MM/YYYY format. In certain embodiments, attribute calculation module 13 performs translation rule on the set of data while performing first and/or second calculations. In other embodiments, first and/or second calculations contain translation rules. As another example, computer 24 may request a report as a raw file. In this instance, attribute calculation module 13 will determine a translation rule from the translation rule set and translate the report to a raw file. Generally, a raw file is an uncompressed collection of data.

Attribute calculation module 13 may receive an attribute calculation update to the attribute calculation rule set from attribute management module 16. The attribute calculation update may update any calculation located in the attribute calculation rule set. For example, attribute calculation update may update the calculation to determine a FICO score, create a new customer risk score, remove an unused calculation, or any other modification, creation, or deletion of calculations located in the attribute calculation rule set. In certain embodiments, attribute calculation module 13 may receive a translation rule update to the translation rule set from attribute management module 16. The translation rule update may update any translations located in the translation rule set. For example, translation rule update may change the format of reporting dollars from thousands to millions, change the format of a date, change the listing of data (e.g., move customer phone number to column 2), or any other modification that changes the style or format of the data.

In an exemplary embodiment of operation, universal keying module 17 may receive a report associated with a customer from computer 24. The report contains customer attributes associated with a customer. The customer attributes may include a household address, accounts owned, tax calculation, collection activity, billing calculations, or any other attributes related to a customer. Universal keying module 17 determines a customer identifier associated with the customer. A customer identifier may be a social security number, bank account number, or any other identifier that will identify the customer from the list of customers of enterprise 12. Alternatively, universal keying module 17 may map one or more customer attributes from the request to a customer identifier, such as a party identifier assigned by enterprise 12.

Universal keying module 17 may associate the customer identifier and customer attributes of the report to a customer identifier in a cross-reference table, the cross-reference table located in enterprise 12. A cross-reference table is a database table that contains common fields with two or more tables within the same database. The cross-reference table in enterprise 12 comprises a customer identifier and a universal key. The universal key is a unique key that is included in the cross-reference table for each customer entity (e.g., each customer entity in the cross-reference table is allocated a unique key). In certain embodiments, accessing the cross-reference table containing the customer identifier and the universal key is prohibited. For a customer identifier not located in the cross-reference table, universal keying module 17 generates a universal key for that customer identifier. In certain embodiments, universal keying module 17 generates a new universal key by creating a unique alphanumeric string to associate with the customer identifier and store in the cross-reference table.

Universal keying module 17 may receive a request for an anonymized report from computer 24. An anonymized report is a report pertaining to one or more customers wherein a customer attribute is listed but the report lacks any customer attributes that identify the customer. An anonymized report may be necessary for enterprise 12 to satisfy certain government regulations. For example, the Gramm-Leach-Bliley Act (“Privacy of Consumer Financial Information”) contains privacy provisions that prohibit the disclosure of a consumer's personal financial information to non-affiliated third parties. The request for an anonymized report may comprise at least one requested customer identifier and indicate requested customer attributes. The request may be communicated from computer 24 external to enterprise 12 (e.g., computer 24 associated with remote vendor 11). The requested customer attributes may include a FICO score, a credit risk score, outstanding loan amount, or any other customer attribute related to a customer.

Universal keying module 17 generates the anonymized report by accessing the cross-reference table and associating the customer identifier with the universal key. The anonymized report contains the universal key and customer attributes corresponding to the requested customer attributes. The universal key and customer attributes are associated with the requested customer identifier. In certain embodiments, universal keying module 17 may scramble the anonymized report by randomly listing the universal key and the associated requested customer attributes of the universal key. Universal keying module 17 communicates the anonymized report to a computer.

In certain embodiments, universal keying module 17 communicates the anonymized report to a governance team. A governance team is an association that is located in enterprise 12 or external to enterprise 12, such as in remote vendor 11. A governance team generally provides support for the delivery of efficient and accountable governance and management processes across enterprise 12 and data communicated to and from enterprise 12. The governance team is any suitable entity that provides support for viewing, managing, implementing, or reporting the enterprise's processes. The governance team may send a transmission approval to universal keying module 17. The transmission approval may indicate that the governance team approves the communication of the anonymized report to computer 24. The governance team may send a transmission disapproval to universal keying module 17 indicating that the governance team does not approve of the communication of the anonymized report to computer 24. Based on the transmission approval or disapproval, universal keying module 17 will transmit the report to computer 24.

In certain embodiments, universal keying module 17 receives a request for an identification of an anonymized report, and the anonymized report contains a unique key. Universal keying module 17 accesses cross-reference table to determine a customer identifier associated with the unique key. Universal keying module 17 communicates the customer identifier to computer 24.

Universal keying module 17 may receive an update from universal keying management module 22. The update may update, modify, add, or delete any information in the cross-reference table in universal keying module 17, including any customer attributes, universal keys, and/or customer identifiers. For example, universal keying management module 22 may modify, add, or delete any customer attributes or customer identifiers within universal keying module 17. In certain embodiments, universal keying management module 22 may ensure that all universal keying modules 17 contain the same information in each of its cross-reference tables. For example, universal keying management module 22 may mirror any change to universal keying module 17 located in remote vendor 11 to universal keying module 17 located in enterprise 12. As another example, universal keying management module 22 may mirror any change to customers associated with enterprise 12 within universal keying module 17 located in remote vendor 11 to universal keying module 17 located in enterprise 12. In other embodiments, enterprise 11 may utilize universal keying management module 22 to add new customer attributes and/or customer identifiers to the cross-reference table in universal keying management module 22. Universal keying management module 22 may transmit updates, modifications, additions, or deletions to universal keying module 17 periodically or instantaneously.

In an exemplary embodiment of operation, data manipulation module 18 may receive transaction data from data source 23. Transaction data comprises any information associated with a transaction and a transaction date, such as financial service information or home equity information. This information may include a transaction type, the goods transacted, the parties involved in the transaction, the amount of the transaction, or any other information pertaining to a transaction of goods or services. The information may be created externally, such as by remote vendor 11, or internally in enterprise 12. Based on the determined transaction date, data manipulation module 18 determines the storage system, first storage system 19 and/or second storage system 20, to store the transaction data. If the transaction date is within a first predetermined period, data manipulation module 18 communicates the received data to first storage system 19 for storage. If the transaction date is within a second predetermined period, data manipulation module 18 communicates the received data to second storage system 20 for storage. The predetermined period may be a specific date, a calculation based on the current date and time, a relationship between the first and second predetermined period, or any other representation of a date that is in comparison to a transaction date. For example, the first determined period may be three years from the current date and the second predetermined period may be ten years from the current date.

In certain embodiments, data manipulation module 18 translates the received data into a format associated with first storage system 19 and/or second storage system 20. As an example, data manipulation module 18 receives data in different formats. As another example, the data may be in a different format than what is required by first storage system 19 and/or second storage system 20. As a final example, first storage system 19 and second storage system 20 may require different formats for data to communicate.

Data manipulation module 18 may receive a request to retrieve stored data. The request may comprise a transaction date of the requested stored data. Data manipulation module 18 determines from which storage system, first storage system 19 or second storage system 20, to retrieve the data. If the transaction date is within the first predetermined period, data manipulation module 18 may retrieve stored data from first storage system 19. If the transaction date is within a second predetermined period, data manipulation module 18 may retrieve stored data from second storage system 20. Data manipulation module 18 may retrieve stored data from the determined storage system and communicate the retrieved data to computer 24.

In certain embodiments, data manipulation module 18 may determine a format associated with a request. After retrieving the stored data from the proper storage system, data manipulation module 18 may translate the retrieved data to a format associated with the request.

Data manipulation module 18 may continuously update first storage system 19 and second storage system 20. For example, data manipulation module 18 determines whether transaction data stored in first storage system 19 is within the second predetermined period. Data manipulation module 18 may extract the stored data from first storage system 19 if the transaction date of the stored data is within the second predetermined period. Data manipulation module 18 may also replicate the stored data from first storage system 19 if the transaction date of the stored data is within the first and second predetermined periods. In an embodiment, data manipulation module 18 verifies whether the extracted data is located in second storage system 20. If the extracted stored data is not located in second storage system 20, data manipulation module 18 may communicate the extracted data to second storage system 20.

In an exemplary embodiment of operation, attribute retrieval module 21 may determine retrievable customer attributes from a plurality of data locations. For example, attribute retrieval module 21 may communicate a request to each data location for the data location to transmit a list of retrievable customer attributes. As another example, attribute retrieval module 21 may receive periodic updates from each data location updating attribute retrieval module 21 as to the data location's retrievable customer attributes. For example, attribute management module 16 and/or universal keying management module 22 may communicate updates regarding retrievable customer attributes associated with a data location to attribute retrieval module 21. As yet another example, attribute retrieval module 21 may retrieve the retrievable customer attributes from each data source. Retrievable customer attributes may include any attributes concerning a customer, characteristics of a business, loan details, or any other information regarding users, financial accounts, products, and/or services. Attribute retrieval module 21 may retrieve any metadata associated with retrievable customer attributes or associate stored metadata with retrievable customer attributes. In certain embodiments, attribute retrieval module 21 may determine the retrievable customer attributes for individual customers from a plurality of data locations. For example, a data location located in remote vendor 11 may contain customer attribute data for potential customers and a data location located in enterprise 11 may contain customer attribute data for current customers.

Data locations may include attribute calculation module 13, database 14, population database 15, universal keying module 17, data manipulation module 18, first storage system 19, second storage system 20, one or more data sources 23, one or more computers 24, and/or any storage of data or interface to a storage of data. Data locations may be located in remote vendor 11, enterprise 12, or a site external to enterprise 12. In certain embodiments, attribute retrieval module 21 communicates the retrievable customer attributes to computer 24. Attribute retrieval module 21 may group retrievable customer attributes according to its data location or according to the type of customer attribute that is able to be retrieved. A user may view and select retrievable customer attributes when creating a customer attribute request at computer 24.

In certain embodiments, attribute retrieval module 21 stores received data reports from previous customer attribute requests. Attribute retrieval module 21 communicates previous customer attribute requests to computer 24 for a user to view and select a previous customer attribute request.

A user may submit a customer attribute request from computer 24 to attribute retrieval module 21. The customer attribute request may include a list of customers and requested customer attributes. The list of customers may include current customers associated with enterprise 12; potential customers associated with enterprise 12; individuals or entities with no relation to enterprise 12; or any individual, entity, group of individuals, or group of entities. In certain embodiments, attribute retrieval module 21 determines a customer identifier for each customer in the list of customers. A customer identifier may be a social security number, bank account number, or any other identifier that will identify the customer from the list of customers of enterprise 12. The requested customer attributes may be a subset of retrievable customer attributes. For example, attribute retrieval module 21 may only accept requested customer attributes that are a subset of retrievable customer attributes. The requested customer attributes may be attributes concerning a customer, characteristics of a business, loan details, or any other information regarding users, financial accounts, products, and/or services. In certain embodiments, the customer attribute request includes a priority of the customer attribute request. The priority may be a numerical indication or designation of the importance of the customer attribute request, an indication of a rush status for the customer attribute request, or any type of indication that communicates the relative importance of the customer attribute request.

Once attribute retrieval module 21 receives the customer attribute request, attribute retrieval module 21 determines the data location of each requested customer attribute. Attribute retrieval module 21 maps each requested customer attribute to a data location that contains that customer attribute. In certain embodiments, if two data location contains the same customer attribute, attribute retrieval module 21 may choose the data location with the least latency (e.g., choosing a data location in enterprise 12 over a data location located in remote vendor 11). In other embodiments, attribute retrieval module 21 determines if a customer attribute is equivalent to a retrieved customer attribute in a prior customer attribute request. Attribute retrieval module 21 may locate the prior customer attribute request instead of determining a data location that contains the customer attribute. In yet another embodiment, attribute retrieval module 21 determines the data location that contains the customer attribute for each individual customer in the customer list or groups of customers in the customer list.

Attribute retrieval module 21 may generate an information call for each data location that attribute retrieval module 21 determined to contain a requested customer attribute for a particular customer. The information call comprises at least one requested customer attribute and one or more customer identifiers. Generally, the information call indicates what customer attributes to retrieve for which customers. Attribute retrieval module 21 may generate the information call in a format particular to each individual data location. In certain embodiments, attribute retrieval module 21 determines if the generated information call is the same as a prior information call. If the generated information call is the same as a prior information call, attribute retrieval module 21 may collect the data report received in response to the prior information call instead of communicating the generated information call. In certain embodiments, attribute retrieval module 21 retrieves the customer attributes for the list of customers from the data location without generating an information call for that data location.

Once attribute retrieval module 21 generates the information call, attribute retrieval module 21 communicates the information call to each data location. In certain embodiments, attribute retrieval module 21 maintains a queue of incomplete information calls (i.e., information calls waiting to be communicated or waiting for information to be received from each data location). Attribute retrieval module 21 may compare the priority of the customer attribute request associated with the information call with the priority of incomplete information calls. If the priority of the customer attribute request exceeds the priority of the incomplete information call, attribute retrieval module 21 places the information call associated with the customer attribute request in front of the incomplete information call in the queue. If the information call is at the front of the queue, attribute retrieval module 21 may communicate the information to the data location. In certain embodiments, attribute retrieval module 21 may communicate the higher priority information call before communicating the lower priority information call. In other embodiments, attribute retrieval module 21 may request the data location to stop processing a previous information call and start processing the current information call.

Attribute retrieval module 21 may receive status updates from a data location indicating the status of responding to the information call. The status updates represent an indication informing attribute retrieval module 21 the progress of responding to the transmitted information call. Attribute retrieval module 21 may communicate the status update to computer 24. In certain embodiments, attribute retrieval module 21 stores the status updates pertaining to a particular data location. Attribute retrieval module 21 may communicate the status updates to computer 24. In an exemplary embodiment, attribute retrieval module 21 may stop the processing of an information call if requested by computer 24.

Attribute retrieval module 21 receives a data report in response to the information call from each data location that attribute retrieval module 21 communicated an information call to. In certain embodiments, attribute retrieval module 21 retrieves the data report from a data location. Once attribute retrieval module 21 receives a data report from a data location, attribute retrieval module 21 may place the data report in a repository for the user of computer 24 to retrieve. In certain embodiments, attribute retrieval module 21 transforms the data report to a format specified by the user. In other embodiments, attribute retrieval module 21 communicates the data report to computer 24.

Attribute retrieval module 21 may generate a complete data report from the data reports received from each data location. Attribute retrieval module 21 may transform and combine portions from each data report. Attribute retrieval module 21 may combine each data report by linking the customer identifier located in each data report. In certain embodiments, attribute retrieval module 21 generates a partial data report from the data reports currently received at attribute retrieval module 21. For example, attribute retrieval module 21 may generate a partial data report based on the data reports currently received even when attribute retrieval module 21 is still waiting on a data report from a data location located in remote vendor 11. Once generating either the overall data report or partial data report, attribute retrieval module 21 communicates overall data report or partial data report to computer 24.

Modifications, additions, or omissions may be made to system 10 without departing from the scope of the invention. For example, system 10 may include any number of attribute calculation modules 13, databases 14, population databases 15, attribute management modules 16, universal keying modules 17, data manipulation modules 18, first storage systems 19, second storage systems 20, attribute retrieval module 21, universal keying management module 22, data sources 23, and computers 24. As another example, attribute calculation module 13 may receive a request for customer information, which may also include customer information on which to perform a first set of calculations. As yet another example, attribute management module 16 may transmit attribute calculation update and translation rule update separately or in the same update. As yet another example, universal keying module 17 may associate an anonymized report with a report's universal key. As yet another example, data manipulation module 18 may communicate transaction data to both first storage system 19 and second storage system 24 or neither storage systems. Data manipulation module 18 may communicate information to any number of storage systems. As a final example, attribute retrieval module 21 may distinguish between the locations of anonymized customer information and non-anonymized customer information. Furthermore, the components of system 10 may be integrated or separated. For example, attribute management module 16, universal keying module 17, and/or data manipulation module 18 may be incorporated into a single component.

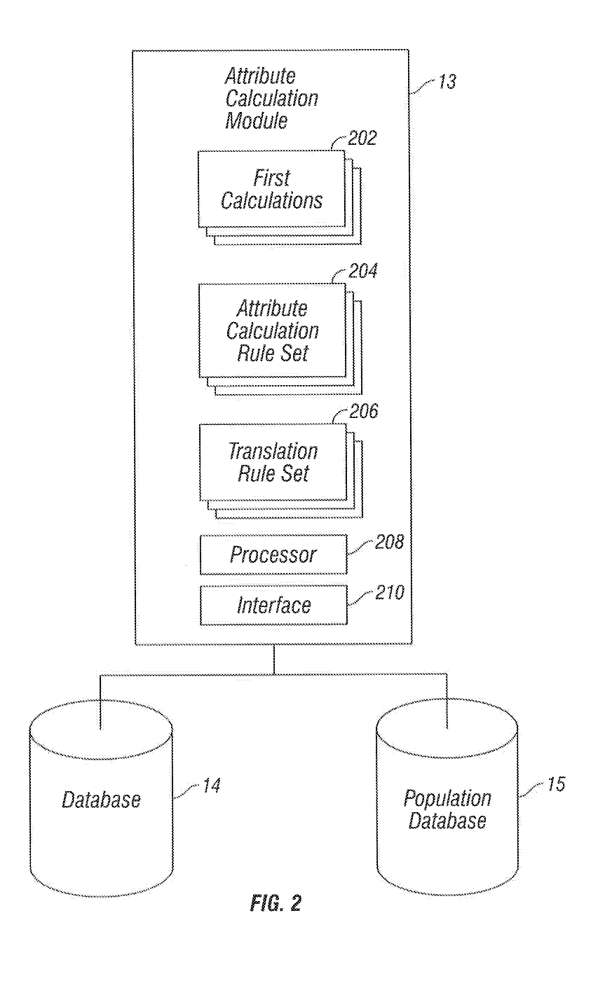

FIG. 2 illustrates a particular embodiment of attribute calculation module 13. Attribute calculation module 13 facilitates the calculating of first and second calculations separately on data.

First calculations 202 represent logic, rules, algorithms, code, tables, and/or other suitable instructions in a computer-readable storage medium for performing a first set of calculations on the received data. For example, first calculations 202 instruct attribute calculation module 13 to conduct a set of operations and/or calculations on the received data.

Attribute calculation rule set 204 represents logic, rules, algorithms, code, tables, and/or other suitable instructions in a computer-readable storage medium for performing attribute calculations on a request from computer 24. Attribute calculation rule set 204 comprises one or more attribute calculations. For example, attribute calculation rule set 204 contains attributes calculations instructing attribute calculation module 13 to conduct a set of operations and/or calculations on the external data to calculate an attribute. Attribute calculation module 13 determines one or more attribute calculations to apply from attribute calculation rule set 204.

Translation rule set 206 represents logic, rules, algorithms, code, tables, and/or other suitable instructions in a computer-readable storage medium for translating calculated external data to an attributes format (i.e., a format suitable for processing by the requesting computer 24). Translation rule set 206 comprises one or more translation rules. For example, translation rule set 206 contains translation rules instructing attribute calculation module 13 to conduct a set of operations and/or calculations on the external data to translate external data to a format specified by database 34. As yet another example, translation rule set 206 contains translation rules instructing attribute calculation module 13 to conduct a set of operations and/or calculations on the calculated external data to translate to an attribute format. As a final example, attribute calculation module 13 determines one or more translation rules to apply from translation rule set 206.

Processor 208 controls the operation and administration of attribute calculation module 13 by processing information received from first calculations 202, attribute calculation rule set 204, translation rule set 206, and interface 210. Processor 208 communicatively couples to first calculations 202, attribute calculation rule set 204, translation rule set 206, and interface 210. Processor 208 includes any hardware and/or software that operates to control and process information. For example, processor 208 accesses first calculations 202 to perform first calculations on the received data for attribute calculation module 13. Processor 208 may be a programmable logic device, a microcontroller, a microprocessor, any suitable processing device, or any suitable combination of the preceding.

Interface 210 represents any suitable device operable to receive information from network 26, transmit information through network 26, perform suitable processing of the information, communicate to other devices, or any combination of the preceding. For example, interface 210 receives data from enterprise 12 on which attribute calculation module 13 performs the first calculations. Interface 210 represents any port or connection, real or virtual, including any suitable hardware and/or software, including protocol conversion and data processing capabilities, to communicate through a LAN, WAN, or other communication system that allows attribute calculation module 13 to exchange information with network 26, enterprise 12, data sources 23, computers 24, and other components of system 10.

Modifications, additions, or omissions may be made to attribute calculation module 13 without departing from the scope of the invention. For example, attribute calculation module 13 may receive a request for customer information and also include customer information on which to perform a first set of calculations. Furthermore, the components of attribute management module 13, database 14, and population database 15 may be integrated or separated. For example, attribute management module 13, database 14, and/or population database 15 may be incorporated into a single component.

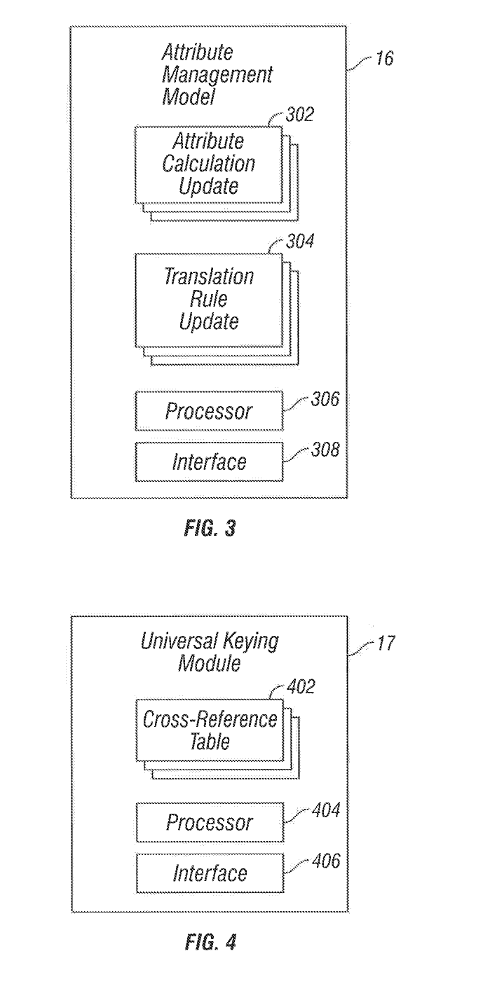

FIG. 3 illustrates a particular embodiment of attribute management module 16. Attribute management module 16 facilitates the communication of an attribute calculation update and/or a translation rule update to attribute calculation module 13.

Attribute calculation update 302 represents logic, rules, algorithms, code, tables, and/or other suitable instructions in a computer-readable storage medium for updating attribute calculation rule set 204 in attribute calculation module 13. For example, attribute calculation update 302 contains instructions for attribute calculation module 13 to create, update, modify and/or delete one or more attribute calculations in attribute calculation rule set 204. Attribute management module 16 communicates attribute calculation update 302 to attribute calculation module 13 instructing attribute calculation module 13 to update attribute calculation rule set 204. In certain embodiments, attribute management module 16 communicates attribute calculation update 302 to more than one attribute calculation modules 13.

Translation rule update 304 represents logic, rules, algorithms, code, tables, and/or other suitable instructions in a computer-readable storage medium for updating translation rule set 206 in attribute calculation module 13. For example, attribute calculation rule set 304 contains instructions for attribute calculation module 13 to create, update, modify, and/or delete one or more translation rules in translation rule set 206. Attribute management module 16 communicates translation rule update 304 to attribute calculation module 13 with instructions to update translation rule set 206. In certain embodiments, attribute management module 16 communicates translation rule update 304 to multiple attribute calculation modules 13.

Processor 306 controls the operation and administration of attribute calculation module 13 by processing information received from attribute calculation update 302, translation rule update 304, and interface 308. Processor 306 communicatively couples to attribute calculation update 302, translation rule update 304, and interface 308. Processor 306 includes any hardware and/or software that operates to control and process information. For example, processor 306 communicates attribute calculation update 302 to attribute calculation module 13 using interface 308. Processor 306 may be a programmable logic device, a microcontroller, a microprocessor, any suitable processing device, or any suitable combination of the preceding.

Interface 308 represents any suitable device operable to receive information from network 26, transmit information through network 26, perform suitable processing of the information, communicate to other devices, or any combination of the preceding. For example, interface 308 communicates translation rule update 304 to attribute calculation module 13 for attribute calculation module 13 to update translation rule set 206. Interface 308 represents any port or connection, real or virtual, including any suitable hardware and/or software, including protocol conversion and data processing capabilities, to communicate through a LAN, WAN, or other communication system that allows attribute management module 16 to exchange information with remote vendor 11, data sources 23, computers 24, network 26, and other components of system 10.

Modifications, additions, or omissions may be made to attribute management module 16 without departing from the scope of the invention. For example, attribute management module 16 may transmit the attribute calculation update and the translation rule update separately or in the same update.

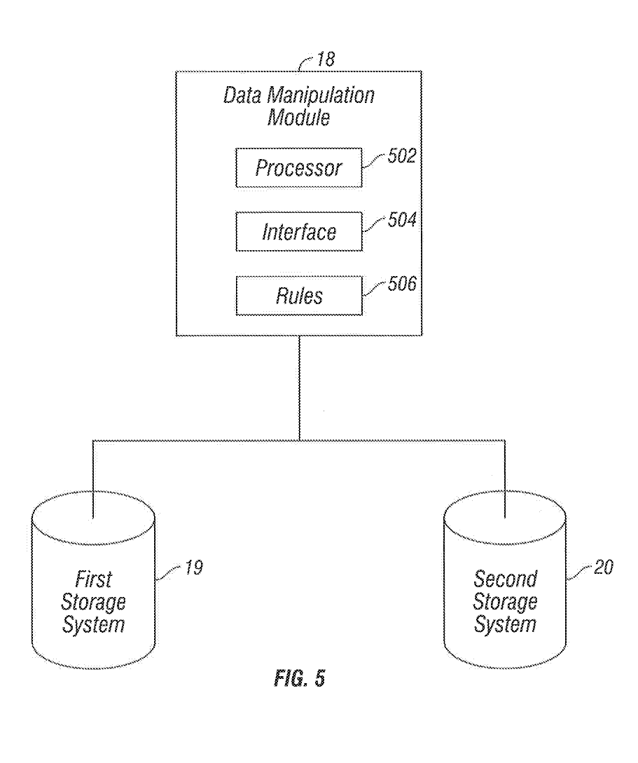

FIG. 4 illustrates a particular embodiment of universal keying module 17. Universal keying module 17 facilitates determining a universal key based on a customer identifier included in a report and transmitting an anonymized report with a universal key associated with a customer.

Cross-reference table 402 represents a database that stores, either permanently or temporarily, the association of one or more customer identifiers with a universal key. For example, cross-reference table 402 associates one or more customer identifiers, such as a social security number, with a universal key. As yet another example, cross-reference table 402 associates one or more customer identifiers with a universal key and associates historical reports with that universal key.

Processor 404 controls the operation and administration of universal keying module 17 by processing information received from cross-reference table 402 and interface 406. Processor 404 communicatively couples to cross-reference table 402 and interface 406. Processor 404 includes any hardware and/or software that operates to control and process information. For example, processor 404 accesses cross-reference table 402 to determine a universal key based on a customer identifier. Processor 404 may be a programmable logic device, a microcontroller, a microprocessor, any suitable processing device, or any suitable combination of the preceding.

Interface 406 represents any suitable device operable to receive information from network 26, transmit information through network 26, perform suitable processing of the information, communicate to other devices, or any combination of the preceding. For example, interface 406 receives a report associated with a customer from computer 24 and communicates an anonymized report to computer 24. Interface 406 represents any port or connection, real or virtual, including any suitable hardware and/or software, including protocol conversion and data processing capabilities, to communicate through a LAN, WAN, or other communication system that allows universal keying module 17 to exchange information with network 26, remote vendor 11, data sources 23, computers 24, and other components of system 10.

Modifications, additions, or omissions may be made to universal keying module 17 without departing from the scope of the invention. For example, universal keying module 17 may associate an anonymized report with the report's universal key.

FIG. 5 illustrates a particular embodiment of data manipulation module 18. Data manipulation module 18 facilitates determining a storage system to store received data based on the transaction date of the received data.

Processor 502 controls the operation and administration of data manipulation module 18 by processing information received from interface 504 and rules 506. Processor 502 communicatively couples to interface 504 and rules 506. Processor 502 includes any hardware and/or software that operates to control and process information. For example, processor 502 utilizes rules 506 to control the operation of data manipulation module 18. Processor 502 may be a programmable logic device, a microcontroller, a microprocessor, any suitable processing device, or any suitable combination of the preceding.

Interface 504 represents any suitable device operable to receive information from network 26, transmit information through network 26, perform suitable processing of the information, communicate to other devices, or any combination of the preceding. For example, interface 504 receives transaction data from data sources 23. Interface 504 represents any port or connection, real or virtual, including any suitable hardware and/or software, including protocol conversion and data processing capabilities, to communicate through a LAN, WAN, or other communication system that allows universal keying module 14 to exchange information with network 26, remote vendor 11, data sources 23, computers 24, and other components of system 10.

Rules 506 generally refer to logic, rules, algorithms, code, tables, and/or other suitable instructions embodied in a computer-readable storage medium for performing the described functions and operations of data manipulation module 18. For example, rules 506 facilitate the determination of a storage system to store received data based on the transaction date of the received data. While illustrated as including a particular module, rules 506 may include any suitable information for use in the operation of data manipulation module 18.

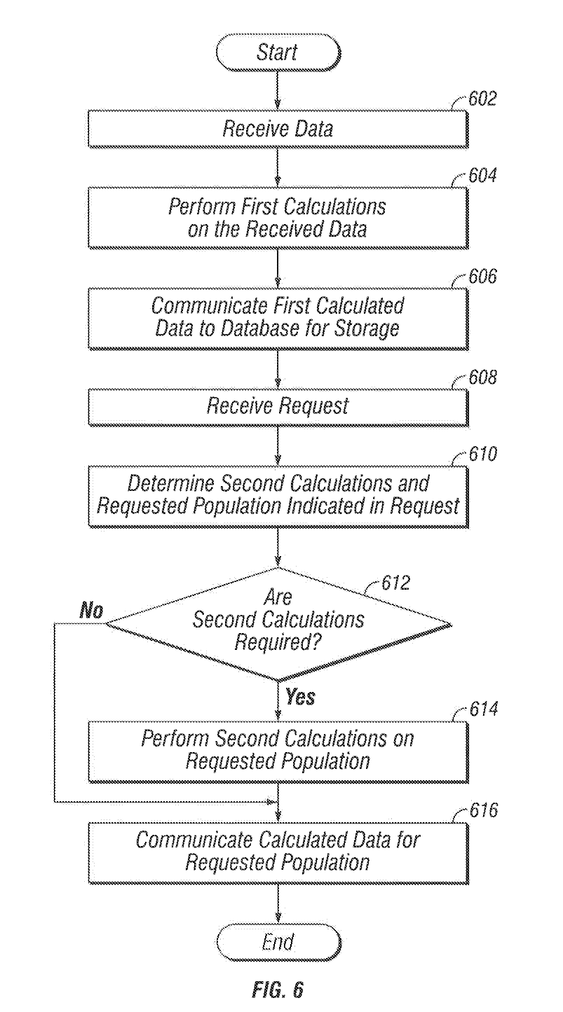

FIG. 6 illustrates an example method for separately calculating first and second calculations on data. The method begins at step 602 when attribute calculation module 13 receives data from enterprise 12. Attribute calculation module 13 performs one or more first calculations 202 on the received data at step 604. Attribute calculation module 13 communicates the first calculated data to database 14 for storage. In certain embodiments, attribute calculation module 13 communicates the first calculated data and the received data to database 14 for storage. In other embodiments, attribute calculation module 13 accesses database 14 and/or population database 15 and performs one or more first calculations 202 on the data located in database 14 and/or population database 15. Attribute calculation module 13 may communicate the first calculated data to population database 15 for storage.

At step 608, attribute calculation module 13 receives a request from computer 24 associated with enterprise 12. The request indicates criteria to conduct one or more second calculations on the requested population, the requested population being all or a portion of the first calculated data. At step 610, attribute calculation module 13 determines the second calculations and requested population indicated in the request. The determination may include determining the location of the requested population. For example, the request may ask for an average FICO score for customers associated with enterprise 12 and, in addition, an average FICO score for the general population of customers. Attribute calculation module 12 may access database 14 to determine the average FICO score for customers associated with enterprise 12 and population database 15 to determine the average FICO score for the general population of customers. In certain embodiments, attribute calculation module 13 determines a random sample of instances in the population database 15 to report upon.

At step 614, attribute calculation module 13 determines if the request requires attribute calculation module 13 to perform second calculations on the retrieved data for the requested population. If the request requires attribute calculation module 13 to perform second calculations, attribute calculation module 13 performs second calculations on the requested population at step 614. However, if the request does not require attribute calculation module 13 to perform second calculations, attribute calculation module 13 may proceed to step 616.

At step 616, attribute calculation module 13 communicates the calculated data to computer 24 associated with enterprise 12. In certain embodiments, attribute calculation module 13 communicates the second calculated data to database 14 for storage.

Modifications, additions, or omissions may be made to the method depicted in FIG. 6. The method may include more, fewer, or other steps. For example, attribute calculation module 13 may communicate the calculated random sample of instances in population database and second calculated data in one communication. As another example, attribute calculation module 13 may receive data and a request from computer 24 associated with enterprise 12. As yet another example, steps may be performed in parallel or in any suitable order. While discussed as attribute calculation module 13 performing the steps, any suitable component of system 10 may perform one or more steps of the method.

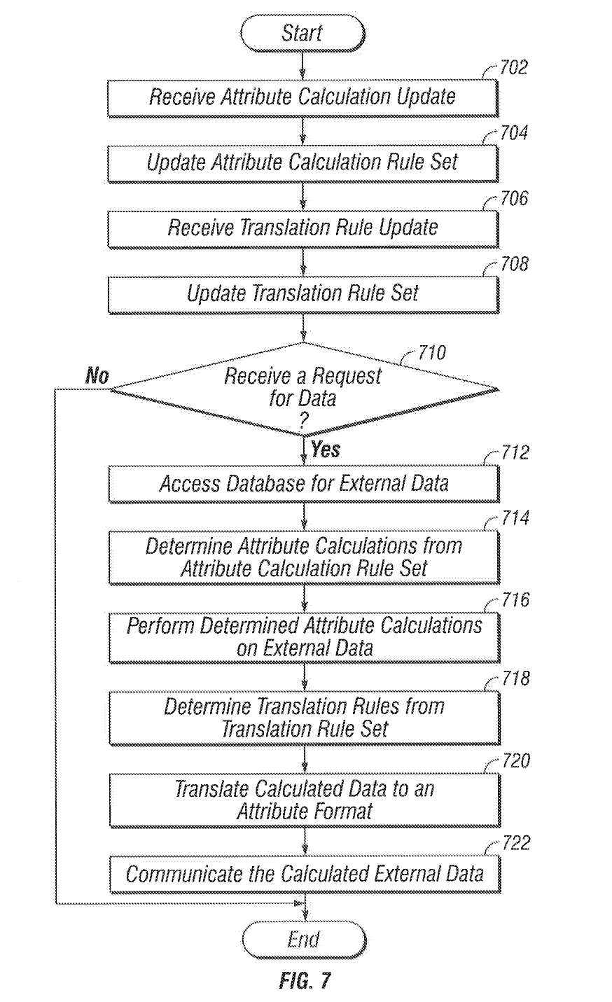

FIG. 7 illustrates an example method for communicating an attribute calculation update and/or a translation rule update. The method begins at step 702 when attribute calculation module 13 receives attribute calculation update 302 from attribute management module 16. Attribute calculation module 13 updates attribute calculation rule set 204 based on attribute calculation update 302 at step 704. At step 706, attribute calculation module 13 receives a translation rule update 304 from attribute management module 16. Attribute calculation module 13 updates translation rule set 206 based on translation rule update 304 at step 708.

At step 710, attribute calculation module 13 determines if attribute calculation module 13 receives a request for attribute data from computer 24 associated with enterprise 12. If attribute calculation module 13 does not receive a request for attribute data, the method may end. However, if attribute calculation module 13 receives a request for attribute data, attribute calculation module 13 accesses database 14 for external data at step 712.

At step 714, attribute calculation module 13 determines attribute calculations from attribute calculation rule set 204 based on the request. Attribute calculation module 13 performs the determined attribute calculations on external data at step 716.

At step 718, attribute calculation module 13 determines translation rules from translation rule set 206 based on the request. Attribute calculation module 13 performs the determined translation rules to translate the calculated external data to an attribute format at step 720. Attribute calculation module 13 communicates the calculated external data to computer 24 associated with enterprise 12 at step 722.

Modifications, additions, or omissions may be made to the method depicted in FIG. 7. The method may include more, fewer, or other steps. For example, attribute calculation module 13 may receive attribute calculation update 302 and not translation rule update 304. As another example, attribute calculation module 13 may receive translation rule update 304 and not attribute calculation update 302. As yet another example, steps may be performed in parallel or in any suitable order. While discussed as attribute calculation module 13 performing the steps, any suitable component of system 10 may perform one or more steps of the method.

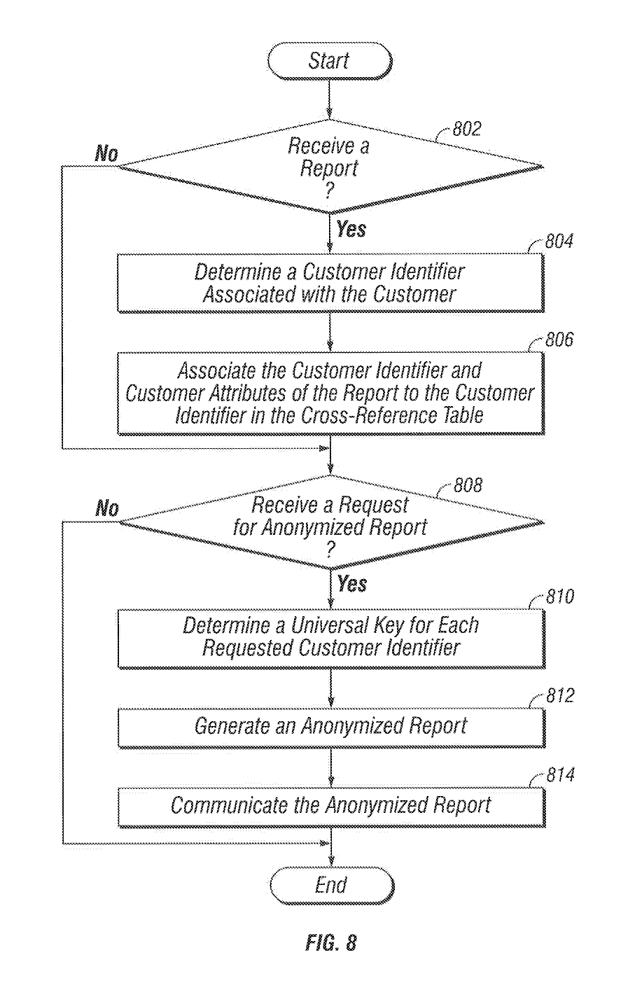

FIG. 8 illustrates an example method for determining a universal key based on a customer identifier included in a report and transmitting an anonymized report with a universal key associated with a customer. The method begins at step 802 when universal keying module 17 determines if universal keying module 17 receives a report associated with a customer from computer 24. If universal keying module 17 does not receive a report, the method proceeds to step 808. However, if universal keying module 17 receives a report, the method proceeds to step 804.

At step 804, universal keying module 17 determines a customer identifier associated with the customer. Universal keying module 17 associates the customer identifier and customer attributes of the report to a customer identifier in cross-reference table 402 at step 806. Cross-reference table 402 comprises a customer identifier and a universal key.

At step 808, universal keying module 17 determines if universal keying module 17 receives a request for an anonymized report from computer 24. The request for an anonymized report may comprise at least one requested customer identifier and indicate requested customer attributes. If universal keying module 17 does not receive a request for an anonymized report, the method may end. However, if universal keying module 17 receives a request for an anonymized report, the method may proceed to step 810.

At step 810, universal keying module 17 determines a universal key for each requested customer identifier by accessing cross-reference table 402 and associating the customer identifier with the universal key. Universal keying module 17 generates the anonymized report by reporting the universal key and customer attributes corresponding to the requested customer attributes at step 812. In certain embodiments, universal keying module 17 may scramble the anonymized report by randomly listing the universal key and the associated requested customer attributes of the universal key. At step 814, universal keying module 17 communicates the anonymized report to computer 24.

Modifications, additions, or omissions may be made to the method depicted in FIG. 8. The method may include more, fewer, or other steps. For example, universal keying module 17 may receive a request for an anonymized report but not receive a report associated with a customer. As yet another example, steps may be performed in parallel or in any suitable order. While discussed as universal keying module 17 performing the steps, any suitable component of system 10 may perform one or more steps of the method.

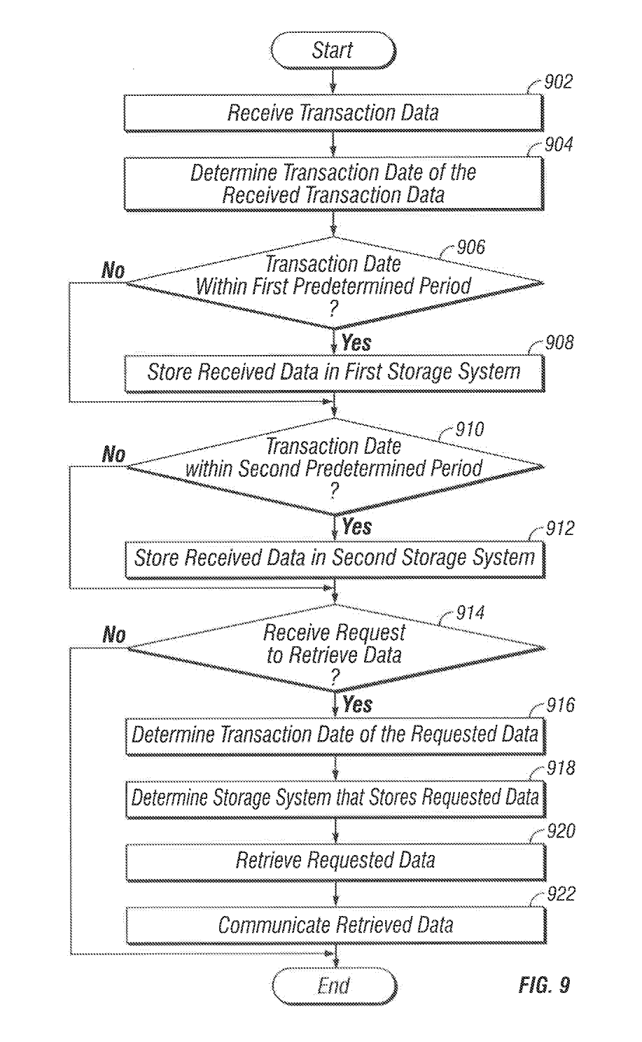

FIG. 9 illustrates an example method for determining a storage system to store received data based on the transaction date of the received data. The method begins at step 902 when data manipulation module 18 receives transaction data from data source 23. At step 904, data manipulation module 18 determines the transaction date of the received transaction data.

At step 906, data manipulation module 18 determines if the transaction date is within the first predetermined period. If transaction date is not within the first predetermined period, the method proceeds to step 910. However, if the transaction date is within the first predetermined period, data manipulation module 18 communicates the received data to first storage system 19 for storage at step 908.

At step 910, data manipulation module 18 determines if the transaction date is within the second predetermined period. If transaction date is not within the second predetermined period, the method proceeds to step 914. However, if the transaction date is within the second predetermined period, data manipulation module 18 communicates the received data to second storage system 20 for storage at step 912.

At step 914, data manipulation module 18 determines if data manipulation module 18 receives a request to retrieve stored data. If data manipulation module 18 does not receive a request to retrieve stored data, the method may end. However, if data manipulation module 18 receives a request to retrieve stored data, the method proceeds to step 916.

At step 916, data manipulation module 18 determines the transaction date of the requested stored date. Data manipulation module 18 determines from which storage system, first storage system 19 and/or second storage system 20, to retrieve the data at step 918. If the transaction date of the requested stored data is within the first predetermined period, data manipulation module 18 may retrieve stored data from first storage system 19. If the transaction date is within the second predetermined period, data manipulation module 18 may retrieve stored data from second storage system 20.

At step 920, data manipulation module 18 retrieves stored data from the determined storage system. Data manipulation module communicates the retrieved data to computer 24 at step 922.

Modifications, additions, or omissions may be made to the method depicted in FIG. 9. The method may include more, fewer, or other steps. For example, data manipulation module 18 may receive a request to retrieve data but not receive transaction data. As another example, data manipulation module 18 may not determine if the transaction date of the received transaction data is within the second predetermined period if data manipulation module determines the transaction date of the received transaction data is within the first predetermined period. As yet another example, steps may be performed in parallel or in any suitable order. While discussed as data manipulation module 18 performing the steps, any suitable component of system 10 may perform one or more steps of the method.

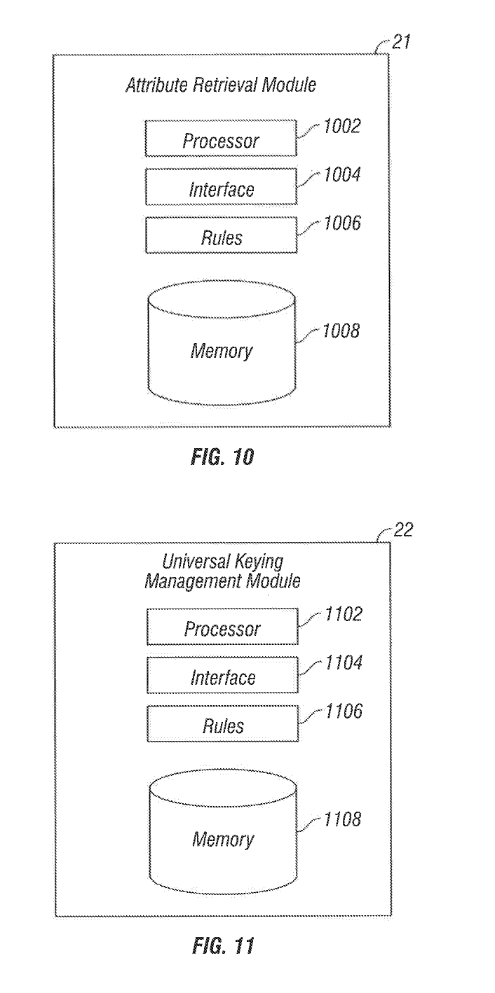

FIG. 10 illustrates a particular embodiment of attribute retrieval module 21. Attribute retrieval module 21 represents any suitable component that facilitates the retrieval of requested customer attributes based on a customer attribute request. In the illustrated embodiment, attribute retrieval module includes processor 1002, interface 1004, rules 1006, and memory 1008.

Processor 1002 controls the operation and administration of attribute retrieval module 21 by processing information received from interface 1004, rules 1006, and memory 1008. Processor 1002 communicatively couples to interface 1004, rules 1006, and memory 1008. Processor 1002 includes any hardware and/or software that operates to control and process information. For example, processor 1002 utilizes rules 1006 to control the operation of attribute retrieval module 21. Processor 1002 may be a programmable logic device, a microcontroller, a microprocessor, any suitable processing device, or any suitable combination of the preceding.

Interface 1004 represents any suitable device operable to receive information from network 26, transmit information through network 26, perform suitable processing of the information, communicate to other devices, or any combination of the preceding. For example, interface 1004 receives customer attribute request from computers 24. Interface 1004 represents any port or connection, real or virtual, including any suitable hardware and/or software, including protocol conversion and data processing capabilities, to communicate through a LAN, WAN, or other communication system that allows attribute retrieval module 21 to exchange information with network 26, remote vendor 11, enterprise 12, data sources 23, computers 24, and other components of system 10.

Rules 1006 generally refer to logic, rules, algorithms, code, tables, and/or other suitable instructions embodied in a computer-readable storage medium for performing the described functions and operations of attribute retrieval module 21. For example, rules 1006 facilitate the determination of the data location of each requested customer attribute. While illustrated as including a particular module, rules 1006 may include any suitable information for use in the operation of attribute retrieval module 21.

Memory 1008 represents a database that stores, either permanently or temporarily, received data reports from prior information calls. Memory 1008 includes any one or a combination of volatile or non-volatile local or remote devices suitable for storing information. For example, memory 1008 may include RAM, ROM, magnetic storage devices, optical storage devices, or any other suitable information storage device or a combination of these devices. Memory 1008 may include any suitable information for use in the operation of attribute retrieval module 21. Additionally, memory 1008 may be a component external to attribute retrieval module 21. Memory 1008 can be located in remote vendor 11, enterprise 12, or any other location suitable for memory 1008 to communicate with attribute retrieval module 21.

FIG. 11 illustrates a particular embodiment of universal keying management module 22. Universal keying management module 22 represents any suitable components that facilitate the communication of updates to one or more universal keying modules 17. In the illustrated embodiment, universal keying management module includes processor 1102, interface 1104, rules 1106, and memory 1108.

Processor 1102 controls the operation and administration of universal keying management module 22 by processing information received from interface 1004, rules 1106, and memory 1108. Processor 1102 communicatively couples to interface 1104, rules 1106, and memory 1108. Processor 1102 includes any hardware and/or software that operates to control and process information. For example, processor 1102 utilizes rules 1106 to control the operation of universal keying management module 22. Processor 1102 may be a programmable logic device, a microcontroller, a microprocessor, any suitable processing device, or any suitable combination of the preceding.

Interface 1104 represents any suitable device operable to receive information from network 26, transmit information through network 26, perform suitable processing of the information, communicate to other devices, or any combination of the preceding. For example, interface 1104 transmits updates to one or more universal keying modules 17. Interface 1104 represents any port or connection, real or virtual, including any suitable hardware and/or software, including protocol conversion and data processing capabilities, to communicate through a LAN, WAN, or other communication system that allows universal keying management module 22 to exchange information with network 26, remote vendor 11, enterprise 12, data sources 23, computers 24, and other components of system 10.

Rules 1106 generally refer to logic, rules, algorithms, code, tables, and/or other suitable instructions embodied in a computer-readable storage medium for performing the described functions and operations of universal keying management module 22. For example, rules 1106 facilitate the determination of when to communicate updates to one or more universal keying modules 17. While illustrated as including a particular module, rules 1106 may include any suitable information for use in the operation of universal keying management module 22.

Memory 1108 represents a database that stores, either permanently or temporarily, updates from universal keying module 17. Memory 1108 includes any one or a combination of volatile or non-volatile local or remote devices suitable for storing information. For example, memory 1108 may include RAM, ROM, magnetic storage devices, optical storage devices, or any other suitable information storage device or a combination of these devices. Memory 1108 may include any suitable information for use in the operation of universal keying management module 22. Additionally, memory 1108 may be a component external to universal keying management module 22. Memory 1108 can be located in remote vendor 11, enterprise 12, or any other location suitable for memory 1108 to communicate with universal keying management module 22.

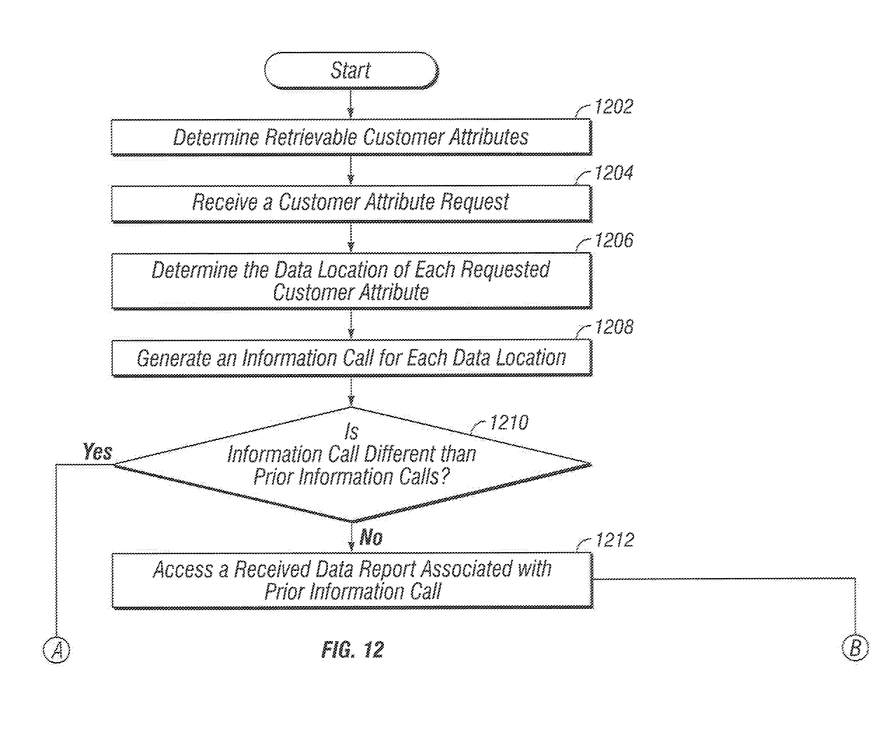

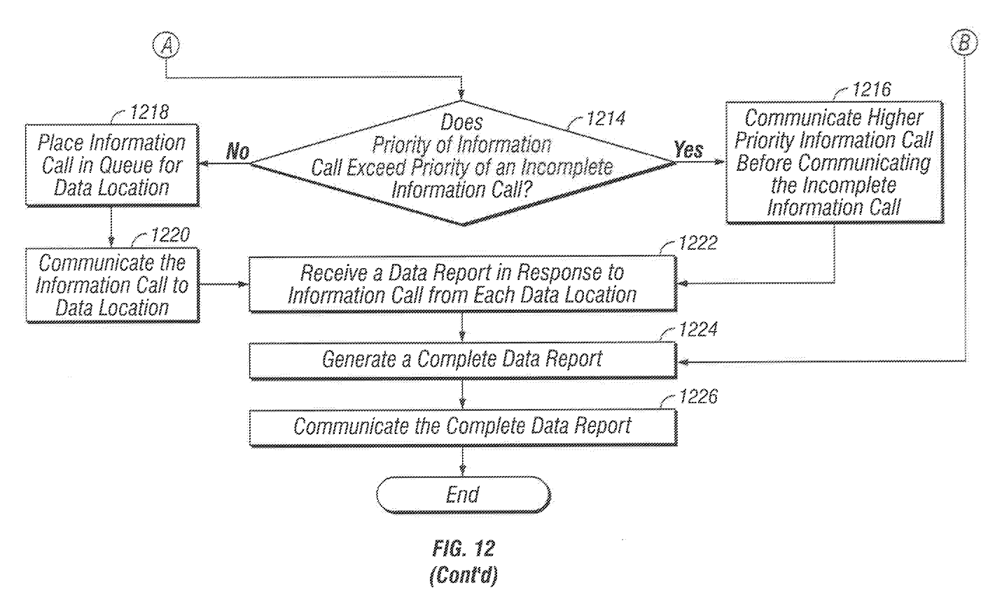

FIG. 12 illustrates an example method for retrieving requested customer attributes based on a received customer attribute request. The method begins at step 1202 when attribute retrieval module 21 determines retrievable customer attributes from a plurality of data locations. For example, attribute retrievable module 21 may communicate a request to each data location for the data location to transmit a list of retrievable customer attributes. At step 1204, attribute retrieval module 21 receives a customer attribute request from computer 24. The customer attribute request may include a list of customers, requested customer attributes, and/or a priority of the customer attribute request.

At step 1206, attribute retrieval module 21 determines the data location of each requested customer attribute. Attribute retrieval module 21 maps each requested customer attribute to a data location that contains that customer attribute. Attribute retrieval module 21 generates an information call for each data location at step 1208. Generally, the information call indicates what customer attributes to retrieve for which customers.

At step 1210, attribute retrieval module 21 determines if the information call is different than prior information calls. If the generated information call is the same as a prior information call, attribute retrieval module 21 may collect the data report from memory 1008 at step 1212. The method then proceeds to step 1224.

If the generated information call is different than the prior information calls, the method proceeds to step 1214. At step 1214, attribute retrieval module 21 compares the priority of the information call with the priority of an incomplete information call. If the priority of the customer attribute request exceeds the priority of the incomplete information call, attribute retrieval module 21 communicates the higher priority information call to the data location before communicating the incomplete information call at 1216 and proceeds to step 1222. If the priority of the customer attribute request does not exceed the priority of the incomplete information call, attribute retrieval module 21 places the generated information call in queue for the data location at step 1218 and proceeds to step 1220. At step 1220, attribute retrieval module 21 communicates the information call to the data location. Attribute retrieval module 21 receives a data report from each data location in response to the communicated information call at step 1222.

In certain embodiments, attribute retrieval module 21 may generate multiple information calls to communicate to data locations at step 1208. For each information call, the method may proceed from step 1210 to step 1222.

At step 1224, attribute retrieval module 21 generates a complete data report from the data reports received from each data location. Attribute retrieval module 21 communicates the complete data report to computer 24 at step 1226.

Modifications, additions, or omissions may be made to the method depicted in FIG. 12. The method may include more, fewer, or other steps. For example, attribute retrieval module 21 may generate multiple information calls to communicate to data locations. As another example, attribute retrieval module 21 may generate a partial data report comprising currently received data reports from data locations. As yet another example, steps may be performed in parallel or in any suitable order. While discussed as attribute retrieval module 21 performing the steps, any suitable component of system 10 may perform one or more steps of the method.

Certain embodiments of the present disclosure may provide one or more technical advantages. A technical advantage of one embodiment includes pre-calculating and storing data at a remote vendor, thereby reducing response time and increasing efficiency when receiving a request. Another technical advantage includes allowing a module located in an enterprise to provide an update to the rule set of a module located at an external vendor, thereby providing greater efficiencies by reducing the number of transactions required between the enterprise and the external vendor to update the rule set. Yet another technical advantage includes a module located in the enterprise creating an anonymized report containing both historical and current customer information, thereby promoting greater visibility into a potential customer's attributes and providing more customer information for an enterprise to view. Yet another technical advantage includes a system to determine a storage system based on the transaction date of the data, which leads to greater efficiencies by utilizing various storage system technologies to store different types of data. Yet another technical advantage includes a system to determine the data location of requested customer attributes and gather the requested customer attributes from each data location, thereby increasing efficiency by automating the retrieval of data from different data locations.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to receive a report associated with a customer from a first computer, the report including customer attributes associated with the customer;
a processor communicatively coupled to the interface and operable to:
determine a customer identifier associated with the customer; and
associate the customer identifier and customer attributes of the report to a customer identifier in a cross-reference table, the cross-reference table internal to an enterprise and comprising the customer identifier and a universal key;
the interface is further operable to receive a request for an anonymized report from a second computer, the request comprising at least one requested customer identifier and indicating requested customer attributes;
the processor is further operable to:
determine the universal key for each requested customer identifier; and
generate the anonymized report, the anonymized report comprising the universal key associated with the requested customer identifier and the requested customer attributes; and
the interface is further operable to communicate the anonymized report to a computer.

2. The system of claim 1, wherein:
the interface is further operable to receive an anonymized report containing a universal key and a customer attribute associated with the universal key; and
the processor is further operable to associate the universal key and customer attribute of the anonymized report to the universal key associated with the cross-reference table.

3. The system of claim 1, wherein the processor is further operable to scramble the anonymized report and the universal key is listed randomly in the report with associated requested customer attributes of the universal key.

4. The system of claim 1, wherein the first computer is external to the enterprise.

5. The system of claim 1, wherein:
the interface is further operable to receive a request for an identification of an anonymous report from a third computer, the request containing a universal key;
the processor is further operable to determine a customer identifier for the universal key; and
the interface is further operable to communicate the customer identifier to the third computer.

6. The system of claim 1, wherein the interface is further operable to:
communicate the anonymized report to a governance team;
receive a transmission approval from the governance team; and
communicate the anonymized report to the second computer.

7. A method, comprising:
receiving, by an interface, a report associated with a customer from a first computer, the report including customer attributes associated with the customer;
determining, by a processor, a customer identifier associated with the customer;
associating, by the processor, the customer identifier and customer attributes of the report to a customer identifier in a cross-reference table, the cross-reference table internal to an enterprise and comprising the customer identifier and a universal key;
receiving, by the interface, a request for an anonymized report from a second computer, the request comprising at least one requested customer identifier and indicating requested customer attributes;
determining, by a processor, the universal key for each requested customer identifier,
generating, by the processor, the anonymized report, the anonymized report comprising the universal key associated with the requested customer identifier and the requested customer attributes; and
communicating, by the interface, the anonymized report to a computer.

8. The method of claim 7, further comprising:
receiving, by the interface, an anonymized report containing a universal key and a customer attribute associated with the universal key; and
associating, by the processor, the universal key and customer attribute of the anonymized report to the universal key associated with the cross-reference table.

9. The method of claim 7, further comprising scrambling, by the processor, the anonymized report, wherein the universal key is listed randomly in the report with associated requested customer attributes of the universal key.

10. The method of claim 7, wherein the first computer is external to the enterprise.

11. The method of claim 7, further comprising:
receiving, by the interface, a request for an identification of an anonymous report from a third computer, the request containing a universal key;
determining, by the processor, a customer identifier for the universal key; and
communicating, by the processor, the customer identifier to the third computer.

12. The method of claim 7, wherein communicating the anonymized report to the second computer comprises:
communicating, by the interface, the anonymized report to a governance team;
receiving, by the interface, a transmission approval from the governance team; and
communicating, by the interface, the anonymized report to the second computer.

13. Non-transitory computer readable medium comprising logic, the logic, when executed by a processor, operable to:
receive a report associated with a customer from a first computer, the report including customer attributes associated with the customer;
determine a customer identifier associated with the customer;
associate the customer identifier and customer attributes of the report to a customer identifier in a cross-reference table, the cross-reference table internal to an enterprise and comprising the customer identifier and a universal key;
receive a request for an anonymized report from a second computer, the request comprising at least one requested customer identifier and indicating requested customer attributes;
determine the universal key for each requested customer identifier;
generate the anonymized report, the anonymized report comprising the universal key associated with the requested customer identifier and the requested customer attributes; and
communicate the anonymized report to a computer.

14. The computer readable medium of claim 13, wherein the logic is further operable to:
receive an anonymized report containing a universal key and a customer attribute associated with the universal key; and
associate the universal key and customer attribute of the anonymized report to the universal key associated with the cross-reference table.

15. The computer readable medium of claim 13, wherein the logic is further operable to scramble the anonymized report and the universal key is listed randomly in the report with associated requested customer attributes of the universal key.

16. The computer readable medium of claim 13, wherein the first computer is external to the enterprise.

17. The computer readable medium of claim 13, wherein the logic is further operable to:
receive a request for an identification of an anonymous report from a third computer, the request containing a universal key;
determine a customer identifier for the universal key; and
communicate the customer identifier to the third computer.

18. The computer readable medium of claim 13, wherein the logic is further operable to:
communicate the anonymized report to a governance team;
receive a transmission approval from the governance team; and
communicate the anonymized report to the second computer.
